(19) United States
(12) Patent Application Publication
(10) Pub. No.: US 2016/0364672 A1
(43) Pub. Date: Dec. 15, 2016

(54) BUSINESS METRIC ILLUMINATION CONTROL

(71) Applicant: Avaya Inc., Santa Clara, CA (US)

(72) Inventors: Tony McCormack, Galway (IE); John H. Yoakum, Cary, NC (US); Neil O'Connor, Galway (IE)

(21) Appl. No.: 14/735,493

(22) Filed: Jun. 10, 2015

(51) Int. Cl. G06Q 10/06

(52) U.S. Cl. CPC G06Q 10/06393

(57) ABSTRACT

Mechanisms for controlling a light system are provided. A first business metric value is received that quantifies a business metric relevant to a business-related entity at a respective time. An illumination state of a plurality of different illumination states of the light system based on the first business metric value is determined. Each illumination state corresponds to an emission of a pattern of electromagnetic radiation of a plurality of different patterns of electromagnetic radiation. The light system is positioned in a location associated with the business-related entity. The light system is signaled to enter the first illumination state.

### TECHNICAL FIELD

The embodiments relate generally to business metrics and, in particular, to business metric illumination control.

### BACKGROUND

Well run businesses maintain business metrics for practically every aspect of the business that relates to profitability. For example, business metrics may quantify performances associated with an employee, throughputs of an assembly line, quantities of inventory, and the like. Such business metrics may be carefully tracked, analyzed, and used to improve processes, justify salary decisions, and for other strategic reasons.

While analyzing business metrics to make strategic decisions about the business is important, it may also be desirable if employees could be provided real-time information regarding business metrics that could be readily perceptible to employees, supervisors, and others in physical proximity to the location at which the relevant business metric is related.

### SUMMARY

The embodiments relate to mechanisms for controlling a light system based on business metrics. The light system is positioned in a location associated with a business entity. As business metric values relevant to the business entity are obtained, the light system is signaled to enter a particular illumination state based on the business metric values. Employees, supervisors, or others within visual distance of the light system can easily and intuitively judge the business metric performance of the business entity based on the particular illumination state.

In one embodiment, a method for controlling a light system is provided. The method includes receiving a first business metric value that quantifies a business metric relevant to a business-related entity at a first time. The method further includes determining a first illumination state of a plurality of different illumination states of a light system based on the first business metric value. Each illumination state corresponds to an emission of a pattern of electromagnetic radiation of a plurality of different patterns of electromagnetic radiation, the light system being positioned in a location associated with the business-related entity. The method further includes signaling the light system to enter the first illumination state.

In one embodiment, the light system utilizes wireless communications. In one embodiment, the first business metric value quantifies a performance metric of an employee, and the location is a workplace location of the employee.

In one embodiment, the workplace location of the employee comprises a desk of the employee.

In one embodiment, the performance metric comprises one of an answered calls count performance metric, a wait time for incoming callers performance metric, an abandoned call count performance metric, a revenue per agent performance metric, a customer satisfaction performance metric, and a first call resolution per service performance metric.

In one embodiment, the first business metric value quantifies an inventory attribute of an inventory, and the location is an inventory location. The inventory attribute comprises one of a quantity inventory attribute, a weight inventory attribute, and a volume inventory attribute.

In one embodiment, the first business metric value quantifies a production line station (PLS) metric of a PLS, and the location is a PLS location. The PLS metric comprises one of processing time, flow rate, percent completion of PLS objective, number or percentage of necessary parts added in the PLS, and weight of an assembly currently in the PLS.

In one embodiment, the plurality of different patterns of electromagnetic radiation comprises a plurality of different colors of light. In another embodiment, the plurality of different patterns of electromagnetic radiation comprises a plurality of different intensities of light. In another embodiment, the plurality of different patterns of electromagnetic radiation comprises a plurality of different changing sequences.

In another embodiment, a light control device for controlling a light is provided. The light control device includes a communication interface configured to communicate with a network. A controller is coupled to the communication interface, and is controller configured to receive a first business metric value that quantifies a business metric relevant to a business-related entity at a first time. A first illumination state of a plurality of different illumination states of a light system is determined based on the first business metric value, each illumination state corresponding to an emission of a pattern of electromagnetic radiation of a plurality of different patterns of electromagnetic radiation, the light system being positioned in a location associated with the business-related entity. The light system is signaled to enter the first illumination state.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram of an environment illustrating business metric illumination control according to one embodiment;

FIG. 2 is a flowchart of a method for implementing business metric illumination control according to one embodiment;

FIG. 3 is a block diagram of an environment illustrating business metric illumination control according to another embodiment;

FIG. 4 is a block diagram of an environment illustrating business metric illumination control according to another embodiment; and

FIG. 5 is a block diagram of a light control device according to one embodiment.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first time” and “second time,” and does not imply a priority, a type, an importance, or other attribute, unless otherwise stated herein.

The embodiments relate to mechanisms for controlling a light system based on business metrics. The light system is within an illumination distance of a location at which a business metric of a business entity is being measured. As business metric values of the business entity are obtained, the light system is signaled to alter a particular illumination state based on the business metric values. Employees within visible distance of the light system can easily and intuitively judge the business metric performance of the business entity based on the particular illumination state.

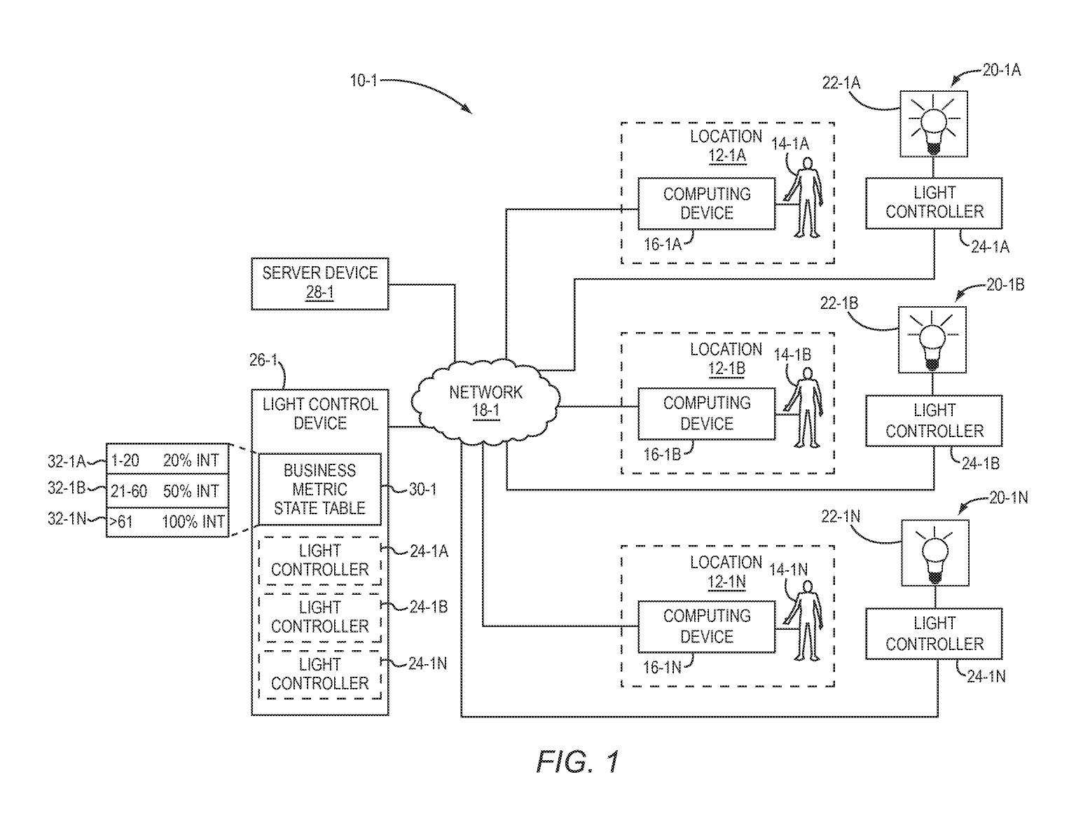

FIG. 1 is a block diagram of an environment 10-1 illustrating business metric illumination control according to one embodiment. The environment 10-1 includes a plurality of locations 12-1A-12-1N (generally, locations 12-1). Corresponding business-related entities, in this example contact center agents 14-1A-14-1N (generally, agents 14-1), are located at the locations 12-1A-12-1N. Each agent 14-1A-14-1N interacts with one of a plurality of computing devices 16-1A-16-1N (generally, computing devices 16-1), in the performance of their business-related job functions. In this example, the locations 12-1 may be cubicles, or offices, in which the agents 14-1 implement contact center-related services, such as helping customers or providing product information for the business entity.

The computing devices 16-1 are communicatively coupled to one or more networks 18-1. Each of a plurality of light systems 20-1A-20-1N (generally, light systems 20-1) illuminates a corresponding location 12-1A-12-1N. Each light system 20-1A-20-1N includes at least one light 22-1A-22-1N (generally, lights 22-1). In some embodiments, the light systems 20-1 may each include a plurality of lights 22-1. Corresponding light controllers 24-1A-24-1N (generally, light controllers 24-1) provide signals, such as analog or digital signals, to the light systems 20-1A-20-1N to place the light systems 20-1A-20-1N in desired illumination states. Each light system 20-1A-20-1N is positioned to illuminate a corresponding location 12-1A-12-1N. Thus, for example, if the location 12-1A comprises a cubicle, the light system 20-1A may be positioned within the cubicle, may be positioned on a pole that extends above the cubicle, or may be positioned in the ceiling above the cubicle. In some embodiments, the light systems 20-1 may utilize wireless communications, and thus illumination states may be controlled wirelessly. In some embodiments, the light systems 20-1 are positioned such that an individual can perceive all, or at least multiple, light systems 20-1 from a particular location, or by moving within an area, and thereby visualize the business metrics in the locations of their relevance.

The light controllers 24-1 are communicatively coupled to, as illustrated in FIG. 1, or, in other embodiments integral with, a light control device 26-1.

The light control device 26-1 is communicatively coupled to a server device 28-1. The light control device 26-1 includes a business metric state table 30-1 that includes a plurality of business metric state entries 32-1A-32-1N, each of which correlates business metric values associated with the agents 14-1 to illumination states of the light systems 20-1.

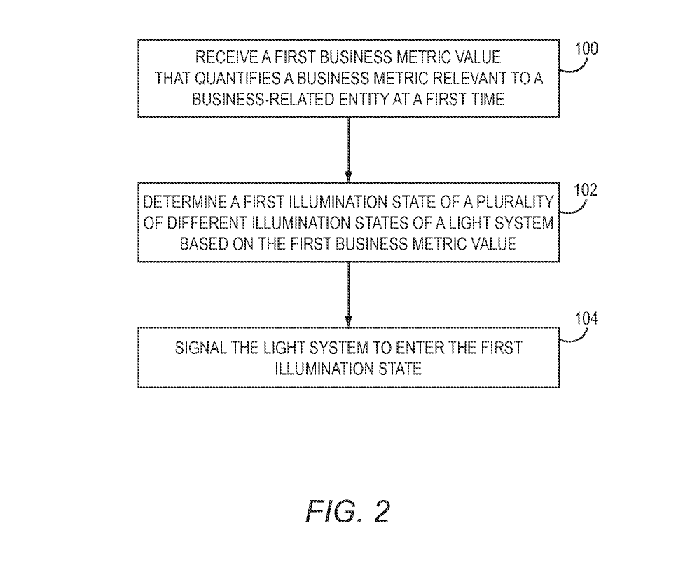

FIG. 2 is a flowchart of a method for implementing business metric illumination control according to one embodiment, and will be discussed in conjunction with FIG. 1. An example embodiment will be discussed with regard to a business-related entity that is an employee, such as the agent 14-1A. The light control device 26-1 receives a first business metric value that quantifies a business metric relevant to the agent 14-1A associated with the location 12-1A at a first time (FIG. 2, block 100). The business metric, in this example, may be any agent performance business metric by which the agent 14-1A may be measured, including, by way of non-limiting example, an answered calls count agent performance business metric, a wait time for incoming callers agent performance business metric, an abandoned call count performance metric, a revenue per agent performance business metric, a customer satisfaction agent performance business metric, or a first call resolution per service agent performance business metric. For purposes of illustration as a non-limiting example, assume that the agent performance business metric comprises an answered calls count agent performance business metric. Further assume that the first business metric value received by the light control device 26-1 is 65. The location 12-1A in this example is a workplace location of the agent 14-1A, such as a desk, cubicle, or office of the agent 14-1A. While for purposes of simplicity and illustration the embodiments are discussed in the context of a single business metric being utilized to determine an illumination state, it will be apparent that any number of business metrics may be considered using any logic desired and utilized to determine an illumination state.

The light control device 26-1 determines a first illumination state of a plurality of different illumination states of the light system 20-1A based on the first business metric value (FIG. 2, block 102). Each illumination state corresponds to an emission pattern of electromagnetic radiation of a plurality of different emission patterns of electromagnetic radiation. The light system 20-1A is positioned to illuminate the location 12-1A. The emission patterns may comprise any different patterns for distinguishing multiple illumination states. By way of non-limiting example, emission patterns may comprise different intensities of a single color, different colors, different changing sequences, and the like. In this example, the light control device 26-1 determines the first illumination state of the plurality of different illumination states by accessing the business metric state table 30-1. The light control device 26-1 determines, based on the business metric state entry 32-1N, that the first illumination state comprises a 100% intensity state based on the received first business metric value of 65. The light system 20-1A is signaled to enter the first illumination state (FIG. 2, block 104). The signals may be digital or may be analog. In this example, the light system 20-1A is signaled to emit light at 100% intensity.

The light control device 26-1 may also receive business metric values that quantify respective agent performance business metrics of the agents 14-1B and 14-1N. Similar to the discussion above with regard to the agent 14-1A, the light control device 26-1 accesses the business metric state table 30-1 and determines respective illumination states for the respective agent performance business metrics of the agents 14-1B and 14-1N. For purposes of illustration, assume that the business metric value associated with the agent 14-1B is 40, and the business metric value associated with the agent 14-1N is 10. Based on the business metric state table 30-1, the light control device 26-1 signals the light system 20-1B to enter an illumination state wherein the light system 20-1B emits light at 50% intensity. The light control device 26-1 signals the light system 20-1N to enter an illumination state wherein the light system 20-1N emits light at 20% intensity. Thus, an individual in view of the light systems 20-1A, 20-1B, 20-1N, knowledgeable about the agent performance business metric being measured, is immediately aware that the agent 14-1A is answering more calls than the agents 14-1B and 14-1N, and that the agent 14-1B is answering more calls than the agent 14-1N.

The light control device 26-1 may receive the business metric values that quantify respective agent performance business metrics of the agents 14-1 periodically, intermittently, or continuously. If the business metric values change, the light control device 26-1 may determine a different illumination state based on the business metric state table 30, and signal the respective light system 20-1 to enter the different illumination state. For example, assume that at a second time subsequent to the first time, the light control device 26-1 receives a second business metric value of 59 for the agent 14-1A. The light control device 26-1 determines a second illumination state based on the second business metric value and the business metric state entry 32-1B. The light system 20-1A is signaled to emit light at 50% intensity rather than 100% intensity.

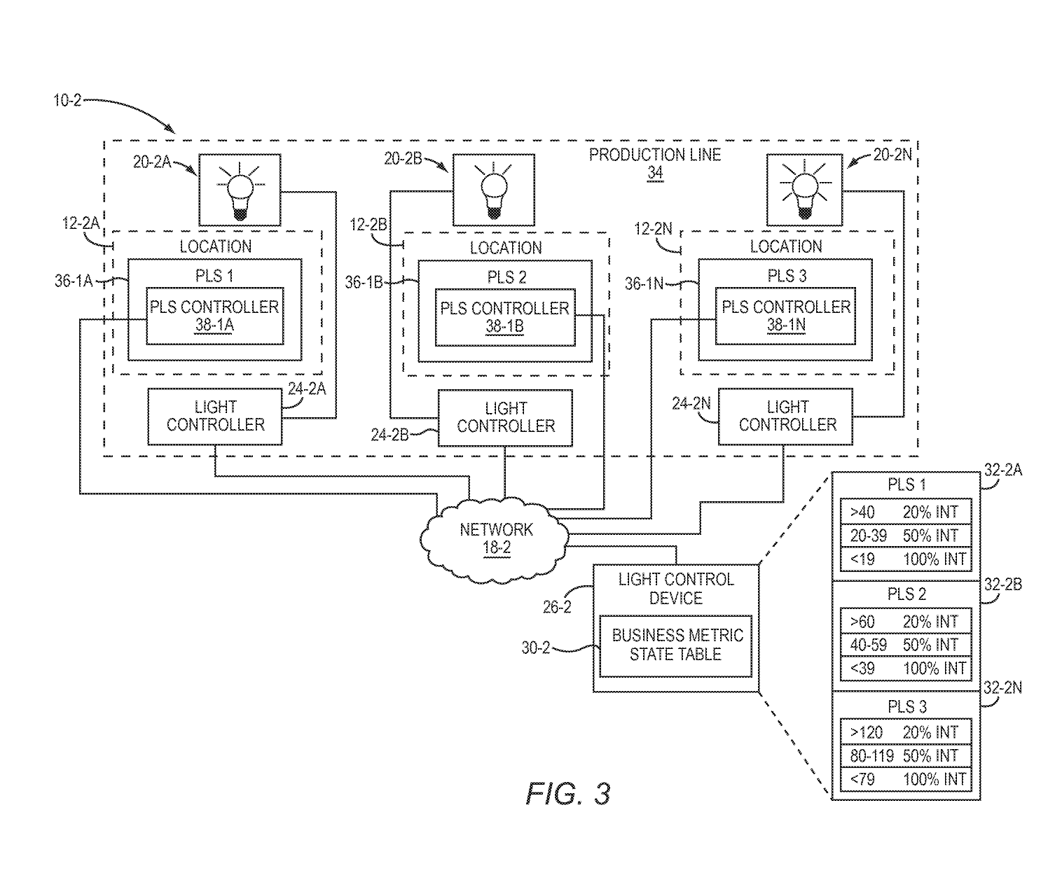

FIG. 3 is a block diagram of an environment 10-2 illustrating business metric illumination control according to another embodiment. In this embodiment, the environment 10-2 includes a production line 34. The production line 34 is, for example, an assembly production line, and includes a plurality of business-related entities referred to herein as production line stations (PLSs) 36-1A-36-1N (generally, PLSs 36-1), each of which is located at a corresponding location 12-2A-12-2N (generally, locations 12-2). At each PLS 36-1, a work piece is partially assembled, such that at the final PLS 36-1N the work piece is completely assembled.

At each PLS 36-1A-PLS 36-1N a corresponding PLS controller 38-1A-38-1N keeps track of at least one business metric, and periodically, intermittently, or continuously provides a business metric value that quantifies the business metric to a light control device 26-2 via one or more networks 18-2. The business metric in this example is a production line (PL) business metric, and may comprise any production line business metric, including, by way of non-limiting example, a processing time PL business metric, a flow rate PL business metric, a percent completion of PLS objective PL business metric, a number or percentage of necessary parts added in the PLS PL business metric, and a weight of an assembly currently in the PLS PL business metric.

As an example, assume that the business metric being tracked, or measured, is a processing time PL business metric that tracks an average amount of time a workpiece is positioned at a respective PLS 36-1 prior to moving to the next PLS 36-1. Desired ranges of business metric values may differ for each PLS 36-1 because the particular components being assembled differ for each PLS 36-1. Thus, in this example, a business metric state table 30-2 comprises a plurality of business metric state entries 32-2A-32-2N, each of which corresponds to one of the PLSs 36-1A-36-1N. Assume that the light control device 26-2 receives, from the PLS controller 38-1A a business metric value of 30, indicating that the average time a workpiece is positioned at the PLS 36-1A is 30 seconds. The light control device 26-2 accesses the business metric state entry 32-2A and, based on the business metric value of 30, signals the light system 20-2A to enter an illumination state wherein the light system 20-2A emits light at 50% intensity. The light control device 26-2 receives, from the PLS controller 38-1 B a business metric value of 70, indicating that the average time a workpiece is positioned at the PLS 36-1B is 70 seconds. The light control device 26-2 accesses the business metric state entry 32-2B and, based on the business metric value of 70, signals the light system 20-2B to enter an illumination state wherein the light system 20-2B emits light at 20% intensity. The light control device 26-2 receives, from the PLS controller 38-1N, a business metric value of 60, indicating that the average time a workpiece is positioned at the PLS 36-1N is 60 seconds. The light control device 26-2 accesses the business metric state entry 32-2N and, based on the business metric value of 60, signals the light system 20-2N to enter an illumination state wherein the light system 20-2N emits light at 100% intensity.

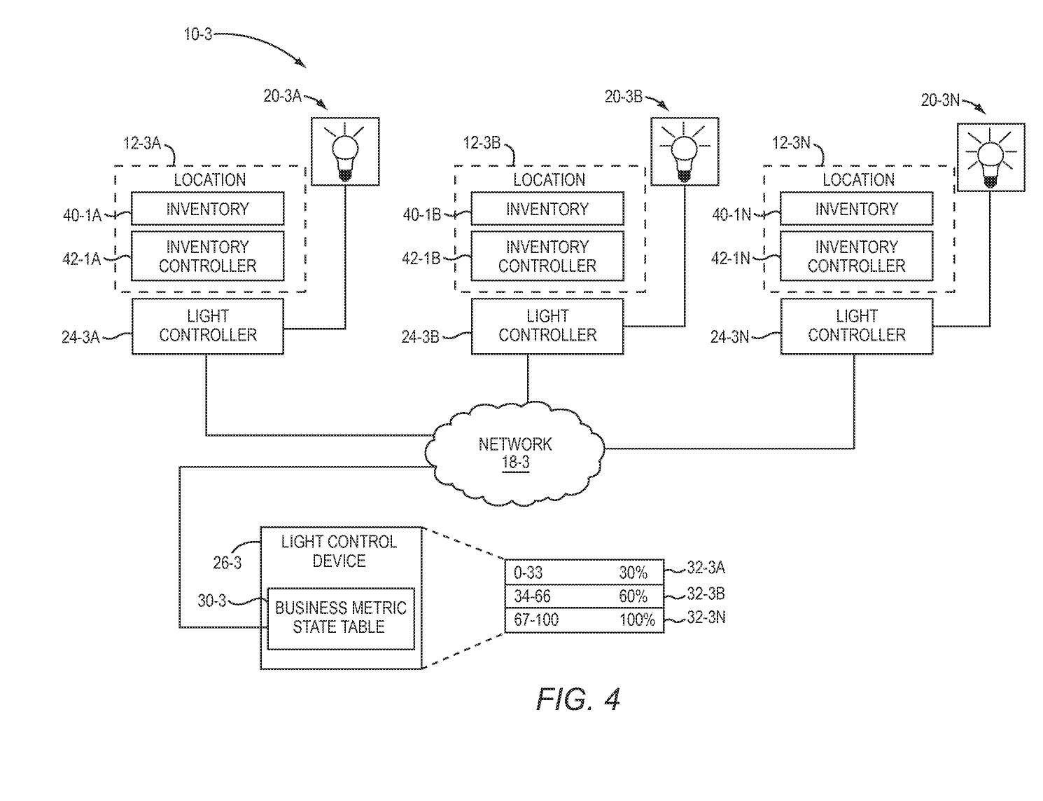

FIG. 4 is a block diagram of an environment 10-3 illustrating business metric illumination control according to another embodiment. In this embodiment, the environment 10-3 includes a plurality of inventory locations 12-3A-12-3N. Each inventory location 12-3A-12-3N includes a business-related entity, which, in this embodiment, comprises inventories 40-1A-40-1N. A plurality of inventory controllers 42-1A-42-1N tracks at least one inventory business metric, and periodically, intermittently, or continuously provides a business metric value that quantifies the inventory business metric to a light control device 26-3 via one or more networks 18-3. The inventory business metric may comprise any suitable metric or attribute of an inventory, including, by way of non-limiting example, an inventory quantity business metric, an inventory weight business metric, and an inventory volume inventory attribute.

As an example, assume that the inventory business metric being tracked, or measured, is an inventory volume business metric that tracks a current volume of inventory. Assume that the light control device 26-3 receives, from the inventory controller 42-1A a business metric value of 30, indicating that the current volume of the inventory 40-1A is 30%. The light control device 26-3 accesses a business metric state table 30-3 and, based on a business metric state entry 32-3A and the business metric value of 30, signals the light system 20-3A to enter an illumination state wherein the light system 20-3A emits light at 30% intensity. The light control device 26-3 receives, from the inventory controller 42-1B a business metric value of 60, indicating that the current volume of the inventory 40-1B is 60%. The light control device 26-3 accesses the business metric state table 30-3 and, based on a business metric state entry 32-3B and the business metric value of 60, signals the light system 20-3B to enter an illumination state wherein the light system 20-3B emits light at 60% intensity. The light control device 26-3 receives, from the inventory controller 42-1N a business metric value of 90, indicating that the current volume of the inventory 40-1N is 90%. The light control device 26-3 accesses the business metric state table 30-3, and based on a business metric state entry 32-3N and the business metric value of 90, signals the light system 20-3N to enter an illumination state wherein the light system 20-3N emits light at 100% intensity.

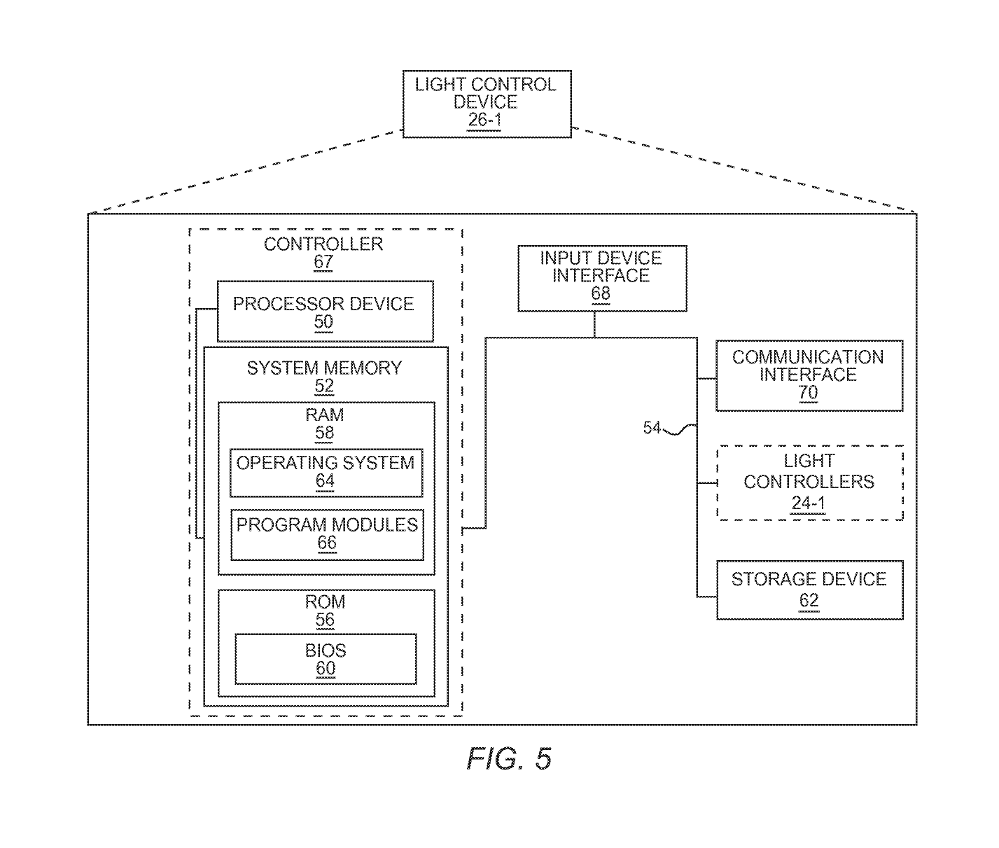

FIG. 5 is a block diagram of the light control device 26-1 according to one embodiment. The light control devices 26-2 and 26-3 may be similarly or identically configured. The light control device 26-1 may comprise any computing or processing device capable of including firmware, hardware, and/or executing software instructions to implement the functionality described herein, including a desktop computer, laptop computer, or special purpose computing device. The light control device 26-1 includes a processor device 50, a system memory 52, and a system bus 54. The system bus 54 provides an interface for system components including, but not limited to, the system memory 52 and the processor device 50. The processor device 50 can be any commercially available or proprietary processor.

The system bus 54 may be any of several types of bus structures that may further interconnect to a memory bus (with or without a memory controller), a peripheral bus, and/or a local bus using any of a variety of commercially available bus architectures. The system memory 52 may include non-volatile memory 56 (e.g., read only memory (ROM), erasable programmable read only memory (EPROM), electrically erasable programmable read only memory (EEPROM), etc.) and/or volatile memory 58 (e.g., random access memory (RAM)). A basic input/output system (BIOS) 60 may be stored in the non-volatile memory 56, and can include the basic routines that help to transfer information between elements within the light control device 26-1. The volatile memory 58 may also include a high-speed RAM, such as static RAM for caching data.

The light control device 26-1 may further include or be coupled to a computer-readable storage device 62, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The computer-readable storage device 62 and other drives, associated with computer-readable media and computer-usable media, may provide non-volatile storage of data, data structures, computer-executable instructions, and the like. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of modules can be stored in the computer-readable storage device 62 and in the volatile memory 58, including an operating system 64 and one or more program modules 66, which may implement the functionality described herein in whole or in part.

All or a portion of the embodiments may be implemented as a computer program product stored on a transitory or non-transitory computer-usable or computer-readable storage medium, such as the computer-readable storage device 62, which includes complex programming instructions, such as complex computer-readable program code, configured to cause the processor device 50 to carry out the steps described herein. Thus, the computer-readable program code can comprise software instructions for implementing the functionality of the embodiments described herein when executed on the processor device 50. The processor device 50, in conjunction with the program modules 66 in the volatile memory 58, may serve as a controller 67 for the light control device 26-1 that is configured to, or adapted to, implement the functionality described herein.

An operator may be able to enter one or more configuration commands through a keyboard (not illustrated), a pointing device such as a mouse (not illustrated), or a touch-sensitive surface (not illustrated). Such input devices may be connected to the processor device 50 through an input device interface 68 that is coupled to the system bus 54, but can be connected by other interfaces such as a parallel port, an Institute of Electrical and Electronic Engineers (IEEE) 1394 serial port, a Universal Serial Bus (USB) port, an IR interface, and the like.

The light control device 26-1 may also include a communication interface 70, suitable for communicating with the network 18-1 and other networks as appropriate or desired, as well as the light controllers 24-1. In some embodiments, the light controllers 24-1 may be integrated into the light control device 26-1.

Those skilled in the art will recognize improvements and modifications to the preferred embodiments of the disclosure. All such improvements and modifications are considered within the scope of the concepts disclosed herein and the claims that follow.

What is claimed is:

1. A method for controlling a light system, comprising:
receiving, by a controller comprising a processor, a first business metric value that quantifies a business metric relevant to a business-related entity at a first time;
determining a first illumination state of a plurality of different illumination states of a light system based on the first business metric value, each illumination state corresponding to an emission of a pattern of electromagnetic radiation of a plurality of different patterns of electromagnetic radiation, the light system being positioned in a location associated with the business-related entity; and
signaling the light system to enter the first illumination state.

2. The method of claim 1, wherein:
determining the first illumination state of the plurality of different illumination states of the light system comprises determining the first illumination state of the plurality of different illumination states of a wireless communications light system; and
signaling the light system to enter the first illumination state comprises wirelessly signaling the wireless communications light system to enter the first illumination state.

3. The method of claim 1, wherein:
receiving the first business metric value that quantifies the business metric relevant to the business-related entity comprises receiving the first business metric value that quantifies a performance metric of an employee; and
the location comprises a workplace location of the employee.

4. The method of claim 3, wherein the performance metric comprises one of an answered calls count performance metric, a wait time for incoming callers performance metric, an abandoned call count performance metric, a revenue per agent performance metric, a customer satisfaction performance metric, and a first call resolution per service performance metric.

5. The method of claim 3, further comprising:
receiving a plurality of business metric values that quantify respective performance metrics of a plurality of employees;
determining respective illumination states for the respective performance metrics; and
signaling each light system of a plurality of light systems to enter a respective illumination state, each light system being positioned to illuminate a respective workplace location of a respective employee.

6. The method of claim 1, wherein:
receiving the first business metric value that quantifies the business metric relevant to the business-related entity comprises receiving the first business metric value that quantifies an inventory attribute of an inventory; and
the location comprises an inventory location.

7. The method of claim 6, wherein the inventory attribute comprises one of a quantity inventory attribute, a weight inventory attribute, and a volume inventory attribute.

8. The method of claim 1, wherein:
receiving the first business metric value that quantifies the business metric relevant to the business-related entity comprises receiving the first business metric value that quantifies a production line station (PLS) metric of a PLS; and
the location comprises a PLS location.

9. The method of claim 8, wherein the PLS metric comprises at least one of processing time, flow rate, percent completion of PLS objective, number or percentage of necessary parts added in the PLS, and weight of an assembly currently in the PLS.

10. The method of claim 1, wherein the plurality of different patterns of electromagnetic radiation comprises a plurality of different colors of light.

11. The method of claim 1, wherein the plurality of different patterns of electromagnetic radiation comprises a plurality of different intensities of light.

12. The method of claim 1, wherein the plurality of different patterns of electromagnetic radiation comprises a plurality of different changing sequences.

13. The method of claim 1, further comprising:
receiving a second business metric value that quantifies the business metric relevant to the business-related entity at a second time that is subsequent to the first time;
determining a second illumination state of the plurality of different illumination states of the light system based on the second business metric value; and
signaling the light system to enter the second illumination state.

14. A light control device for controlling a light, comprising:
a communication interface configured to communicate with a network; and
a controller comprising a processor coupled to the communication interface, the controller configured to:
receive a first business metric value that quantifies a business metric relevant to a business-related entity at a first time;
determine a first illumination state of a plurality of different illumination states of a light system based on the first business metric value, each illumination state corresponding to an emission of a pattern of electromagnetic radiation of a plurality of different patterns of electromagnetic radiation, the light system being positioned in a location associated with the business-related entity; and
signal the light system to enter the first illumination state.

15. The light control device of claim 14 wherein to determine the first illumination state of the plurality of different illumination states of the light system the controller is further configured to determine the first illumination state of the plurality of different illumination states of a wireless communications light system and wherein to signal the light system to enter the first illumination state the controller is further configured to wirelessly signal the wireless communications light system to enter the first illumination state.

16. The light control device of claim 14, wherein to receive the first business metric value that quantifies the business metric relevant to the business-related entity, the controller is further configured to receive the first business metric value that quantifies a performance metric of an employee; and wherein the location comprises a workplace location of the employee.

17. The light control device of claim 14, wherein the plurality of different patterns of electromagnetic radiation comprises a plurality of different colors of light.

18. The light control device of claim 14, wherein the plurality of different patterns of electromagnetic radiation comprises a plurality of different intensities of light.

19. The light control device of claim 14, wherein the plurality of different patterns of electromagnetic radiation comprises a plurality of different changing sequences.

20. The light control device of claim 14, wherein the controller is further configured to:
receive a second business metric value that quantifies the business metric relevant to the business-related entity at a second time that is subsequent to the first time;
determine a second illumination state of the plurality of different illumination states of the light system based on the second business metric value; and
signal the light system to enter the second illumination state.
